(19) United States
(12) Patent Application Publication
(10) Pub. No.: US 2016/0006190 A1
(43) Pub. Date: Jan. 7, 2016

(54) ELECTRICAL CABLE AND POWER SUPPLY DEVICE

(71) Applicant: SANYO ELECTRIC CO., LTD., Osaka (JP)

(72) Inventors: MAKOTO KATSUURA, Hyogo (JP); SHOGO SUMITOMO, Hyogo (JP); HIROYUKI MIHARA, Hyogo (JP); KOICHI INOUE, Hyogo (JP); TAKAHIRO YAMASHITA, Hyogo (JP); YOSHIKAZU ITAKURA, Osaka (JP); TAKUYA IMAI, Osaka (JP)

(21) Appl. No.: 14/769,747

(22) PCT Filed: Sep. 9, 2014
(86) PCT No.: PCT/JP2014/004615

§ 371 Date: Aug. 21, 2015

(30) Foreign Application Priority Data
Oct. 24, 2013 (JP) 2013-220797
Nov. 13, 2013 (JP) 2013-234699
Mar. 11, 2014 (JP) 2014-047176

(51) Int. Cl. H01R 13/72; H01R 13/696; H01R 13/70; H01R 13/66; G05B 11/01; H01R 24/28

(52) U.S. Cl. CPC H01R 13/72; G05B 11/01; H01R 24/28; H01R 13/70; H01R 13/6616; H01R 13/696; H01R 2107/00

(57) ABSTRACT

An electric cable through which power is provided from a power supply device to an electric device, includes an electrical connecting line group having power supply lines for supplying power by a plus side power supply line and a minus-side power supply-line, and a temperature measuring line to wire the temperature measuring line and the power supply line in parallel disposition, a plug disposed to at least one end of the electrical connecting line group, and a thermal sensitive element connected to the power supply line and the temperature measuring line, and disposed inside the plug.

### TECHNICAL FIELD

The present disclosure is related to an electric cable and a power supply device using its electric cable which connects the power supply device and a portable electric device when the power supply device supplies power to the portable electric device.

### BACKGROUND ART

A conventional electric cable is disclosed in patent literature 1. The personal digital assistant is configured to efficiently radiate heat of electric parts outside a housing case in a state where a plug of the electric cable is inserted to a connector. Namely, the personal digital assistant includes a circuit board provided in the housing case, the connector made of metal fixed on an outer case, the electric parts generating heat for operation and fixed at a different location from the location of the connector on the main surface of the circuit board, and a thermal conductive member which contacts main bodies of the electric parts and the outer case of the connector, and conducts heat from the electric parts to the connector.

In patent literature 2, in the electric cable for supplying power to an electric vehicle, temperature sensors are provided in the power source plug or the charging coupler. When temperature of the temperature sensor is increased, the electric cable determines that abnormal heat generation occurs, and can control charging current.

### CITATION LIST

### Patent Literature

Patent Literature 1: Japanese Laid-Open Patent Publication No. 2012-94695

Patent Literature 2: Japanese Laid-Open Patent Publication No. 2012-196120

### SUMMARY OF THE INVENTION

In the above conventional electric cable, when power is supplied in a state where the plug of its tip is inserted into the connector of the electric device, abnormal heat generation occurs due to the case where conductive foreign objects exist between the plug and the connector, or short circuit between terminals by deformation of the plug, heat deformation of the electric device (especially deformation of a resin housing case) may happen.

As the electric cable for the electric vehicle is a large size, it is easy that a temperature sensor, a temperature measuring line, or a temperature measuring terminal is provided. However, as the electric cable for a portable electric device has a small type of the plug, it is difficult to newly set a temperature measuring line, or a temperature measuring terminal. In addition, when the standardized shapes of the plug and connecter are used, it is impossible to increase wiring lines or terminals.

The present disclosure is developed for the purpose of solving such problems. One non-limiting and explanatory embodiment provides an electric cable or the like where abnormal heat generation is prevented when power is supplied through a small type plug or a standardized plug.

An electric cable of the present disclosure comprises an electrical connecting line group having power supply lines for supplying power by a plus side power supply line and a minus side power supply line, and a temperature measuring line to wire the temperature measuring line and the power supply line in parallel disposition, a plug disposed to at least one end of the electrical connecting line group, and a thermal sensitive element connected to the power supply line and the temperature measuring line, and disposed inside the plug. Then, temperature of the plug is measured.

Accordingly, as temperature of a small type plug or a standardized plug can be measured, heat generation of the plug is detected, and then charging current can be controlled.

Accordingly, abnormal high temperature of the plug is prevented even in the electric cable using a small type plug or a standardized plug.

### BRIEF DESCRIPTION OF DRAWINGS

FIG. 1 is a schematic view showing an electric cable of an embodiment of the present invention.

FIG. 2 is a schematic view and a disassembled view of a plug of the embodiment of the present invention.

FIG. 3 is a circuit diagram showing the electric cable of an embodiment 1 of the present invention.

FIG. 4 is a circuit diagram showing the electric cable of an embodiment 2 of the present invention.

FIG. 5 is a circuit diagram showing the electric cable of an embodiment 3 of the present invention.

FIG. 6 is a circuit diagram showing a direct current power supply device of an embodiment 3 of the present invention.

FIG. 7 is a circuit diagram showing the electric cable of an embodiment 4 of the present invention.

FIG. 8 is a circuit diagram showing the electric cable of an embodiment 5 of the present invention.

FIG. 9 is a circuit diagram showing the electric cable of an embodiment 6 of the present invention.

FIG. 10 is a circuit diagram showing the electric cable of an embodiment 7 of the present invention.

FIG. 11 is a circuit diagram showing the electric cable of an embodiment 8 of the present invention.

FIG. 12 is a circuit diagram showing the electric cable of an embodiment 9 of the present invention.

FIG. 13 is a circuit diagram showing the electric cable of an embodiment 10 of the present invention.

FIG. 14 is a circuit diagram showing the electric cable of an embodiment 11 of the present invention.

FIG. 15 is a circuit diagram showing the electric cable in an application of the embodiment 11 of the present invention.

FIG. 16 is a circuit diagram showing the electric cable of an embodiment 12 of the present invention.

FIG. 17 is an outer appearance view showing another embodiment of the present invention.

### DESCRIPTION OF EMBODIMENTS

Embodiments of the present invention are explained in the following, referring to figures.

### Embodiment 1

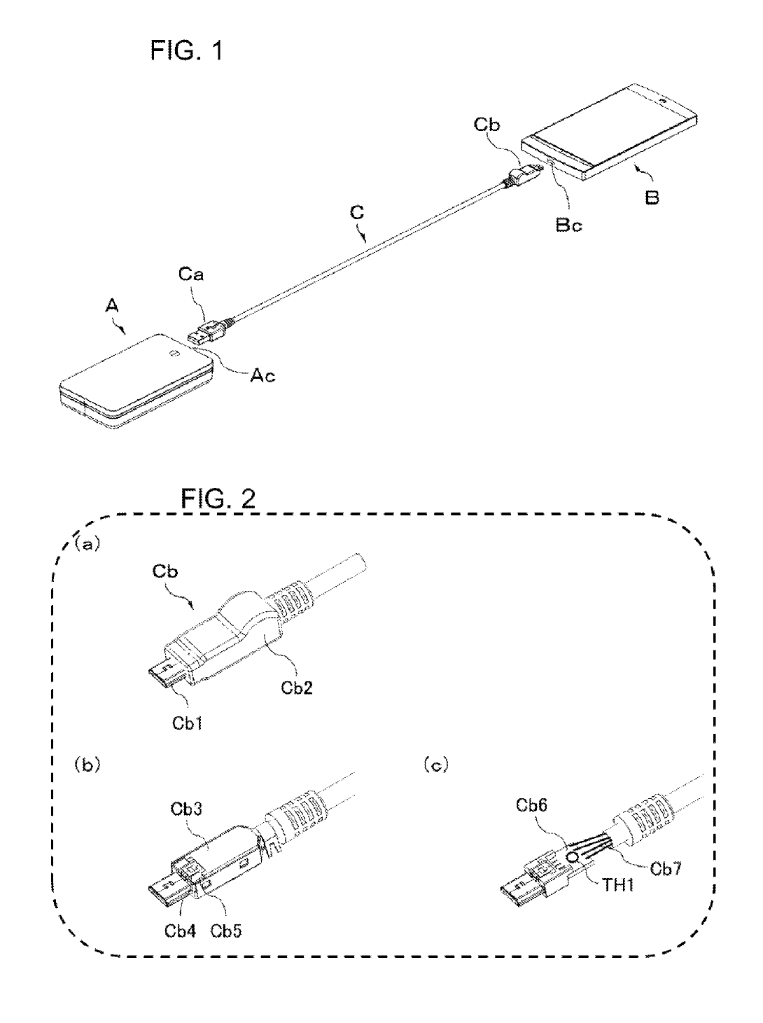

The embodiment of the present invention is explained in detail, referring to figures. FIG. 1 is a schematic view showing the embodiment of the present invention. An electric device B incorporating a secondary battery (not shown) such as a smart phone or a mobile phone, a direct current power supply device A supplying power to this of an external auxiliary battery pack, and an electric cable C connecting these, are shown in FIG. 1. In place of the direct current power supply device A, an AC adapter which converts an alternating current commercial power supply to a direct current power supply can be also used as the direct current power supply device A.

As shown in FIG. 1, the direct current power supply device A has a connector Ac which outputs direct current power. The electric device B has a connector Bc into which direct current power is inputted. The electric cable C has a plug Ca connected to the connector Ac of the direct current power supply device A, and a plug Cb connected to the connector Bc into which direct current power is inputted, in both ends thereof.

The connectors Ac, Bc, the plugs Ca, Cb have structures corresponding to the standards of the USB, the mini-USB, the micro-USB, and the lightening connector and plug.

The structure of the plug Cb of the electric cable C is shown in FIG. 2. In FIG. 2, FIG. 2(a) is a schematic view, and FIG. 2(a), (b) are disassembled views of the plug of the embodiment of the present invention. As shown in FIG. 2(a), the plug Cb includes an insert portion Cb1 which is inserted into the connector Bc of the electric device B, and an outer mold portion Cb2 formed of a resin in the outer appearance.

As shown in FIG. 2(b), when the outer mold portion Cb2 of the plug Cb is detached, there is a metal chassis Cb3 which is coupled to the insert portion Cb1, and the metal chassis Cb3 is electrically connected to the frame ground of the insert portion Cb1. In the connection of the insert portion Cb1 and the metal chassis Cb3, there is partially a cutout portion Cb4, and a core portion Cb5 formed of a resin is exposed from the metal chassis Cb3.

As shown in FIG. 2(c), when the metal chassis Cb3 of the plug Cb is detached, a thermal sensitive element TH1 (for example, a thermistor) is disposed at the circuit board Cb6, and the circuit board Cb6 is held by the core portion Cb5. An electrical connecting line group Cb1 comprises four lines of a plus side power supply line C1, a minus side power supply line C2, an electric connecting line CD+, and an electric connecting line CD−.

To measure a temperature by the thermal sensitive element TH1 close to the temperature generated at the insert portion Cb1, the insert portion Cb1, the core portion Cb5, and the circuit board Cb6 at which the thermal sensitive element TH1 is disposed, are physically connected. To suppress that heat generated at the insert portion Cb1 is thermally diffused to the metal chassis Cb3, the cutout portion Cb4 is formed between the insert portion Cb1 and the metal chassis Cb3. A resin portion having a heat conduction coefficient of 0.2 (W/mK) or less, for example, PE (polyethylene) resin, or an air layer portion is disposed between the metal chassis Cb3 and the circuit board Cb6 at which the thermal sensitive element TH1 is disposed.

It is preferable that the metal chassis Cb3 surrounds the whole periphery as a shielding function, so that signal noises are not mixed in the circuit board Cb6 or the electrical connecting line group Cb7. However, as mentioned above, the cutout portion Cb4 is partially formed at the core portion Cb5 to prevent heat from being diffused to the metal chassis Cb3.

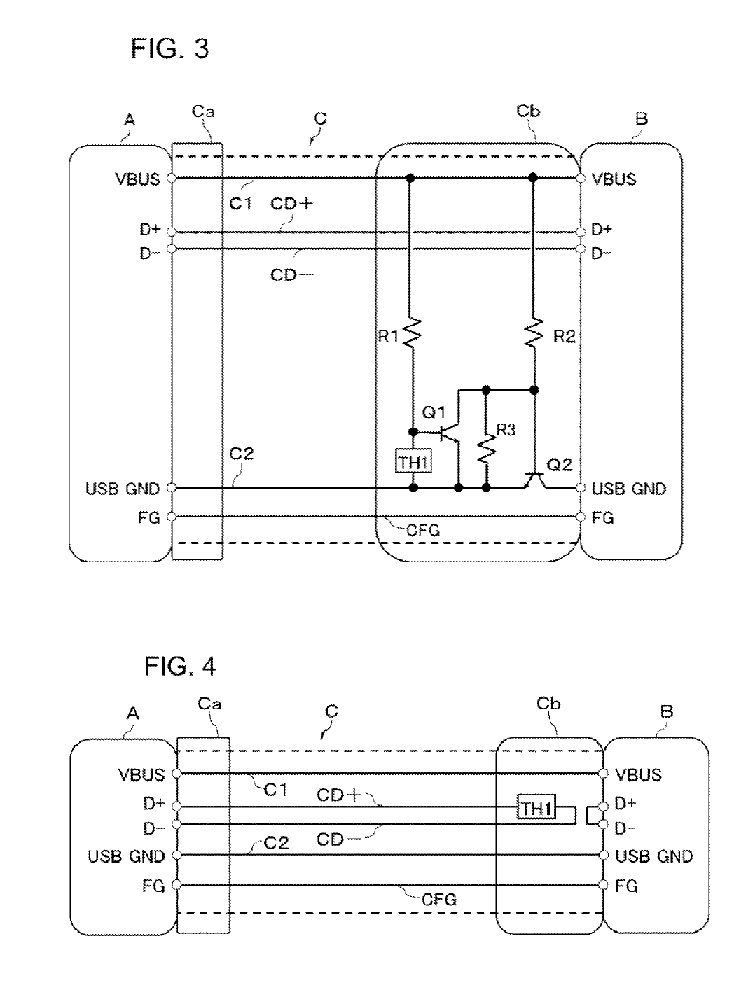

Next, the electrical connecting line group Cb7 is explained. FIG. 3 is a circuit diagram showing an embodiment 1 of the present invention. As shown in FIG. 3, the electrical connecting line group Cb7 in the electric cable C comprises four lines of the plus side power supply line C1 connecting terminals VBUS, the minus side power supply line C2 connecting terminals USB_GND, the electric connecting line CD+ connecting terminals D+, and the electric connecting line CD− connecting terminals D−. A frame ground line CFG connecting terminals FG is provided, and the electrical connecting line group Cb7 is surrounded and covered with the frame ground line CFG having a braded shape (not shown) to protect the electrical connecting line group Cb7 against noises.

In this embodiment, the plug Cb of the one end portion includes the thermal sensitive element TH1, resistors R1, R2, and R3, and a switching elements (transistor) Q1 and Q2. The switching element Q2 is inserted, connected in series to the minus side power supply line C2. When the plug Cb becomes high temperature, the switching element Q2 is turned off by change in resistance value of the thermal sensitive element TH1, and then it makes the minus side power supply line C2 an open circuit.

In the embodiment 1 of FIG. 3, the thermal sensitive element TH1 has a positive temperature characteristic, and its resistance value suddenly becomes large. The thermal sensitive element TH1 has the resistance value of about 10 kΩ at the normal temperature range of about 25° C., and the resistance value of about 100 kΩ or more at the high temperature range of about 60° C. or more. A series circuit of the thermal sensitive element TH1 and a resistor R1 of 620 kΩ is connected between the plus side power supply line C1 and the minus side power supply line C2. A resistor R2 of 100 kΩ is connected between the base of the switching circuit element Q2 and the plus side power supply line C1.

The base of the switching element (transistor) Q1 is connected to a middle point of the resistor R1 and the thermal sensitive element TH1, and the emitter of the switching element Q1 is connected to the minus side power supply line C2, and the collector of the switching element Q1 is connected to a middle point of the base of the switching element Q2 and the resistor R2. A resistor R3 of 1 MΩ is connected between the minus side power supply line C2 and the middle point of the base of the switching element Q2 and the resistor R2.

In the above circuit, at the normal temperature range of the thermal sensitive element TH1, as the resistance value of the thermal sensitive element TH1 is low, the base electric potential of the switching element Q1 is low, and then the switching element Q1 is in the OFF state. Then, as the divided voltage of the resistor R2 and the resistor R3 is applied to the base of the switching element Q2, the base electric potential is high, and then the switching element Q2 is in the ON state. Therefore, power can be supplied from the direct current power supply device A to the electric device B through the electric cable C.

When abnormal heat generation occurs due to the case where conductive foreign objects exist, the resistance value of the thermal sensitive element TH1 becomes 100 kΩ or more in the high temperature range of the thermal sensitive element TH1. Then, the base electric potential of the switching element Q1 becomes high, and the switching element Q1 becomes the ON state. Therefore, the base electric potential of the switching element Q2 becomes low, and the switching element Q2 becomes the OFF state. Thus, in the high temperature range, power supply from the direct current power supply device A to the electric device B through the electric cable C, is stopped.

As a modified example of FIG. 3, a thermal sensitive element having a negative temperature characteristic is used, and in place of R1 of FIG. 3, this thermal sensitive element is used, and in place of the thermal sensitive element TH1 of FIG. 3, a resistor is disposed. In this case, operations of the switching element Q1, Q2 are the same as the above description in the normal, high temperature range.

### Embodiment 2

The circuit configuration of the embodiment 2 of the present invention is shown in FIG. 4. In the differences of the embodiment 2 and the embodiment 1, the switching element Q1, Q2, and the resistor R1 to R3 are removed, and connections of thermal sensitive element TH1 are changed. Other elements are the same as the embodiment 1. In the same elements as the embodiment 1, the same marks are put, and their explanations are omitted.

As shown in FIG. 4, in the plug Cb, the thermal sensitive element TH1 is connected to the electric connecting line CD+ which is connected to the terminal D+ of the plug Ca, and is connected to the terminal D− of the plug Ca through the electric connecting line CD−. The electric connecting line CD+ and the electric connecting line CD− are used as temperature measuring lines.

In place of connecting the thermal sensitive element TH1 to the terminal D− of the plug Ca through the electric connecting line CD−, the thermal sensitive element TH1 may be grounded to the terminal USB_GND through the minus side power supply line C2

In the direct current power supply device A, a controlling portion of the direct current power supply device A detects the resistance value (or, voltage or divided voltage applied to this), and calculates the temperature of the plug Cb. When the controlling portion of the direct current power supply device A detects that the plug Cb becomes the predetermined protection temperature 60° C. or more, it stops direct current power supply from the direct current power supply device A.

In place of the thermal sensitive element TH1, a thermal sensitive element TH2 in which the resistance value decreases in non-linear with temperature increase, can be used. The thermal sensitive element TH2 has about 10 kΩ at the normal temperature 25° C., and the resistance value to temperature changes in non-linear as a numerical formula 1.

R=R0×exp{D×(1/T−1/T0)} (numerical formula 1)
R: resistance value (kΩ) of the thermal sensitive element TH2
R0: resistance value of the thermal sensitive element at normal temperature 25° C.
D: a constant of 4250
T: temperature (° C.) of the thermal sensitive element TH2
T0: normal temperature 25° C.

In the thermal sensitive element TH2, by using the characteristics in which the resistance value to the temperature changes, change of the resistance value per unit time can be obtained. Concretely, by sampling the temperature of the thermal sensitive element TH2 at a predetermined time interval, the temperature increase per unit time of ΔT/Δt can be obtained.

Namely, by using the thermal sensitive element TH2, when the controlling portion of the direct current power supply device A detects that the plug Cb becomes equal to or more than the predetermined protection temperature (for example 60° C.), or that the temperature increase per unit time of ΔT/Δt becomes equal to or more than a predetermined value (for example, the temperature increase of 5 (degree) during 20 seconds), it can stop direct current power supply from the direct current power supply device A. Here, the predetermined value of the temperature increase per unit time of Δ T/Δt is set so as to change it depending on the temperature (for example, 5 degrees at 20° C., 10 degrees at 10° C., not detect at 0° C.), and then an erroneous detection by changing of the ambient environment temperature can be prevented.

### Embodiment 3

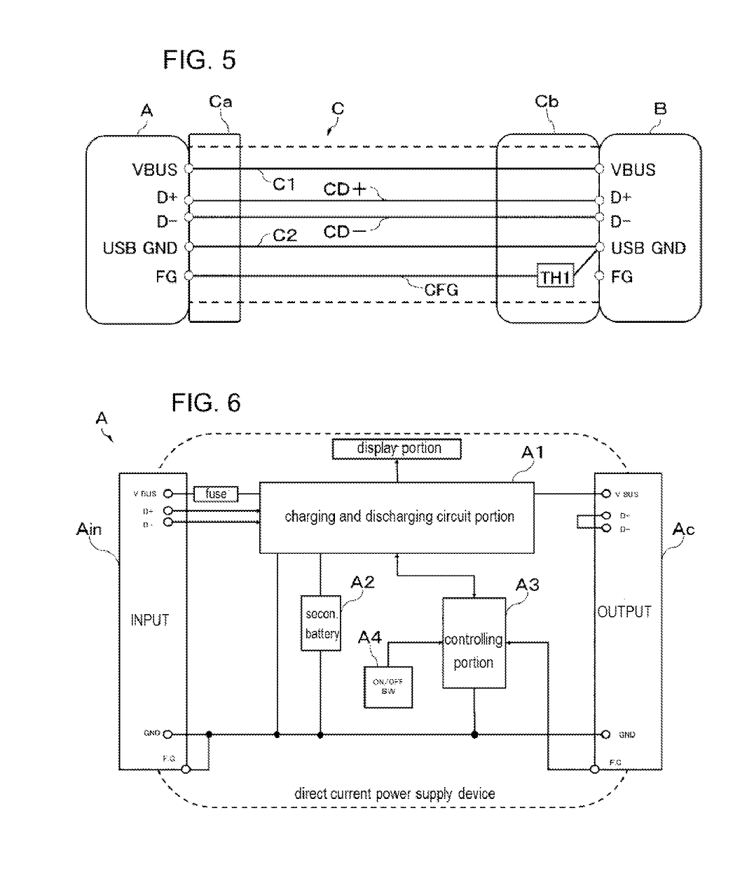

The circuit configuration of the embodiment 3 of the present invention is shown in FIG. 5. In the differences of the embodiment 3 and the embodiment 1, the switching element Q1, Q2, and the resistor R1 to R3 are removed, and connections of thermal sensitive element TH1 are changed. Other elements are the same as the embodiment 1. In the same elements as the embodiment 1, the same marks are put, and their explanations are omitted.

As shown in FIG. 5, in the plug Cb, the thermal sensitive element TH1 is connected to the minus side power supply line C2 which is connected to the terminal USB_GND of the plug Ca, and is connected to the terminal FG of the plug Ca through the frame ground line CFG. The frame ground line CFG is used as a temperature measuring line of the thermal sensitive element TH1.

As the minus side power supply line C2 is connected to the terminal USB_GND of the plug Ca and the terminal USB_GND of the plug Cb, the thermal sensitive element TH1 may be connected to the minus side power supply line C2 or the terminal USB_GND of the plug Cb.

Next, the direct current power supply device A of FIG. 6 is explained. FIG. 6 is a circuit diagram showing the direct current power supply device of an embodiment 3 of the present invention. As shown in FIG. 6, power is inputted into a connector Ain (the USB connector) of the direct current power supply device A, and power is outputted from a connector Ac. Power input of the direct current power supply device A is not limited to the USB connector, and an AC adaptor or other input connectors may be used.

As shown in FIG. 6, the direct current power supply device A inputs power from the connector Ain, and charges a secondary battery A2 with power through a charging and discharging circuit portion A1. Then, the direct current power supply device A outputs power stored in the secondary battery A2 through the charging and discharging circuit portion A1 from the connector Ac to the electric cable C. The direct current power supply device A has a controlling portion A3 into which information from an ON/OFF switch A4 and the terminal FG of the connector Ac is inputted. The controlling portion A3 controls the charging and discharging circuit portion based on the inputted information.

The controlling portion A3 detects the resistance value (or, voltage or divided voltage applied to this) of the thermal sensitive element TH1 from the terminal FG, and calculates the temperature of the plug Cb. When the controlling portion A3 detects that the plug Cb becomes the predetermined protection temperature 60° C. or more, the controlling portion A3 controls the charging and discharging circuit portion Al so as to stop power supply from the secondary battery A2.

In place of the thermal sensitive element TH1, the thermal sensitive element TH2 in which the resistance value decreases in non-linear with temperature increase, can be used. The thermal sensitive element TH2 has about 10 kΩ at the normal temperature 25° C., and the resistance value to temperature changes in non-linear as the numerical formula 1.

By using the characteristic in which the resistance value to the temperature changes, change of the resistance value per unit time can be obtained. Thus, the temperature increase per unit time of ΔT/Δt of the thermal sensitive element TH2 can be obtained.

Namely, by using the thermal sensitive element TH2, when the controlling portion A3 detects that the plug Cb becomes equal to or more than the predetermined protection temperature (for example 60° C.), or that the temperature increase per unit time of ΔT/Δt becomes equal to or more than a predetermined value (for example, the temperature increase of 5 (degree) during 20 seconds), it can stop direct current power supply from the direct current power supply device A. Here, the predetermined value of the temperature increase per unit time of ΔT/Δt is set so as to change it depending on the temperature (for example, 5 degrees at 20° C., 10 degrees at 10° C., not detect at 0° C.), and then an erroneous detection by changing of the ambient environment temperature can be prevented.

### Embodiment 4

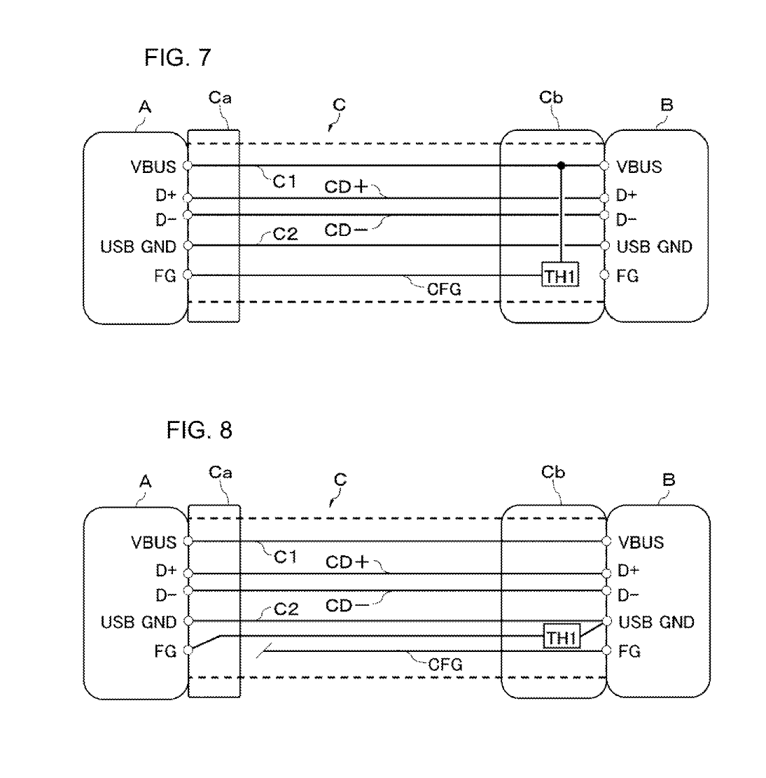

The circuit configuration of the embodiment 4 of the present invention is shown in FIG. 7. In the differences of the embodiment 4 and the embodiment 3, connections of thermal sensitive element TH1 or TH2 are changed. Other elements are the same as the embodiment 3. In the same elements as the embodiment 3, the same marks are put, and their explanations are omitted.

As shown in FIG. 7, in the plug Cb, the thermal sensitive element TH1 is connected to the plus side power supply line C1 which is connected to the terminal VBUS of the plug Ca, and is connected to the terminal FG of the plug Ca through the frame ground line CFG. The frame ground line CFG is used as a temperature measuring line of the thermal sensitive element TH1.

As the plus side power supply line C1 is connected to the terminal VBUS of the plug Ca and the terminal VBUS of the plug Cb, the thermal sensitive element TH1 may be connected to the plus side power supply line C1 or the terminal VBUS of the plug Cb.

In the embodiment 4 in the same way as the embodiment 3, at the abnormal time when the temperature becomes the high temperature range or the temperature increase per unit time becomes equal to or more than a predetermined value, direct current power supply from the direct current power supply device A can be stopped. Further, in the embodiment 4, as the thermal sensitive element TH1 or TH2 is connected to the plus side power supply line C1, the electric potential difference of both ends of the thermal sensitive element becomes large, compared with the embodiment 3, and then the resistance value of the thermal sensitive element can be made large. Therefore, measurement error of the resistance value becomes small, and then the temperature can be exactly measured.

### Embodiment 5

The circuit configuration of the embodiment 5 of the present invention is shown in FIG. 8. In the differences of the embodiment 5 and the embodiment 3, connections of thermal sensitive element TH1 or TH2 are changed to an electric connecting line C3. Other elements are the same as the embodiment 3. In the same elements as the embodiment 3, the same marks are put, and their explanations are omitted.

As shown in FIG. 8, in the plug Cb, the thermal sensitive element TH1 is connected to the minus side power supply line C2 which is connected to the terminal USB_GNU of the plug Ca, and is connected to the terminal FG of the plug Ca through the newly added electric connecting line C3 as a temperature measuring line of the thermal sensitive element TH1. The frame ground line CFG is not connected to the plug Ca, but is connected to the terminal FG of the plug Cb.

In the embodiment 5 of the same way as the embodiment 3, at the abnormal time when the temperature becomes the high temperature range or the temperature increase per unit time becomes equal to or more than a predetermined value, direct current power supply from the direct current power supply device A can be stopped.

### Embodiment 6

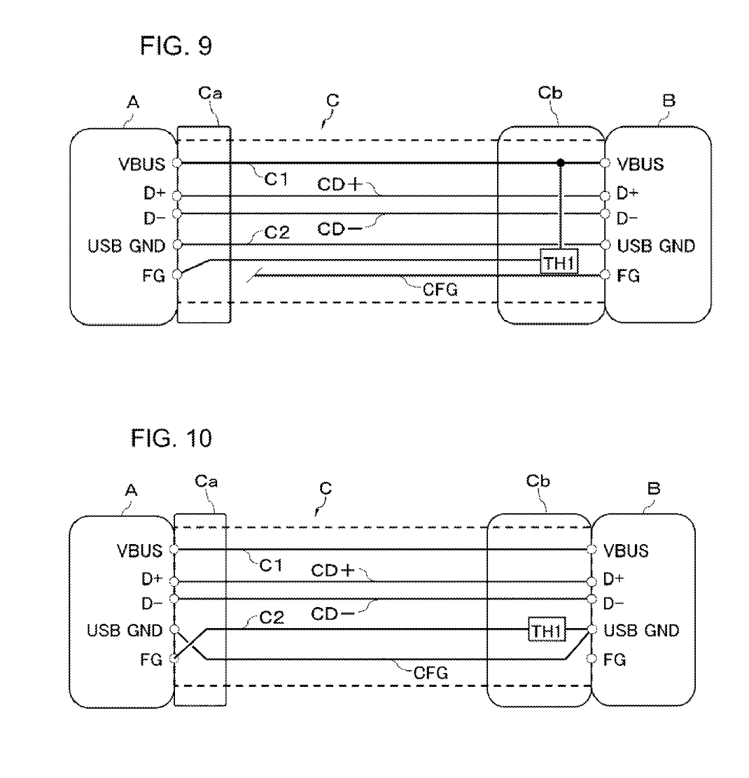

The circuit configuration of the embodiment 6 of the present invention is shown in FIG. 9. In the differences of the embodiment 6 and the embodiment 4, connections of the thermal sensitive element TH1 or TH2 are changed to an electric connecting line C3. Other elements are the same as the embodiment 4. In the same elements as the embodiment 4, the same marks are put, and their explanations are omitted.

As shown in FIG. 9, in the plug Cb, the thermal sensitive element TH1 is connected to the plus side power supply line C1 which is connected to the terminal VBUS of the plug Ca, and is connected to the terminal FG of the plug Ca through the newly added electric connecting line C3 as a temperature measuring line of the thermal sensitive element TH1. The frame ground line CFG is not connected to the plug Ca, but is connected to the terminal FG of the plug Cb.

In the embodiment 6 of the same way as the embodiment 4, at the abnormal time when the temperature becomes the high temperature range or the temperature increase per unit time becomes equal to or more than a predetermined value, direct current power supply from the direct current power supply device A can be stopped. Measurement error of the resistance value becomes small, and then the temperature can be exactly measured.

### Embodiment 7

The circuit configuration of the embodiment 7 of the present invention is shown in FIG. 10, In the differences of the embodiment 7 and the embodiment 3, connections of the minus side power supply line C2 and the frame ground line CFG are changed. Other elements are the same as the embodiment 3. In the same elements as the embodiment 3, the same marks are put, and their explanations are omitted.

As shown in FIG. 10, in the plug Cb, the thermal sensitive element TH1 is connected to the frame ground line CFG which is connected to the terminal USB_GND of the plug Ca, and is connected to the terminal FG of the plug Ca through the minus side power supply line C2. The terminals USB_GND of the plug Ca, Cb are connected by the frame ground line CFG. The minus side power supply line C2 is used as a temperature measuring line of the thermal sensitive element TH1.

In the embodiment 6 in the same way as the embodiment 4, at the abnormal time when the temperature becomes the high temperature range or the temperature increase per unit time becomes equal to or more than a predetermined value, direct current power supply from the direct current power supply device A can be stopped, In the embodiment 7, as the terminals USB_GND are connected by the frame ground line CFG having a low resistance value (about 35 mΩ/m), compared with the minus side power supply line C2 (about 100 mΩ/m, in the case of AWG 24 line), power loss of charging current can be reduced.

### Embodiment 8

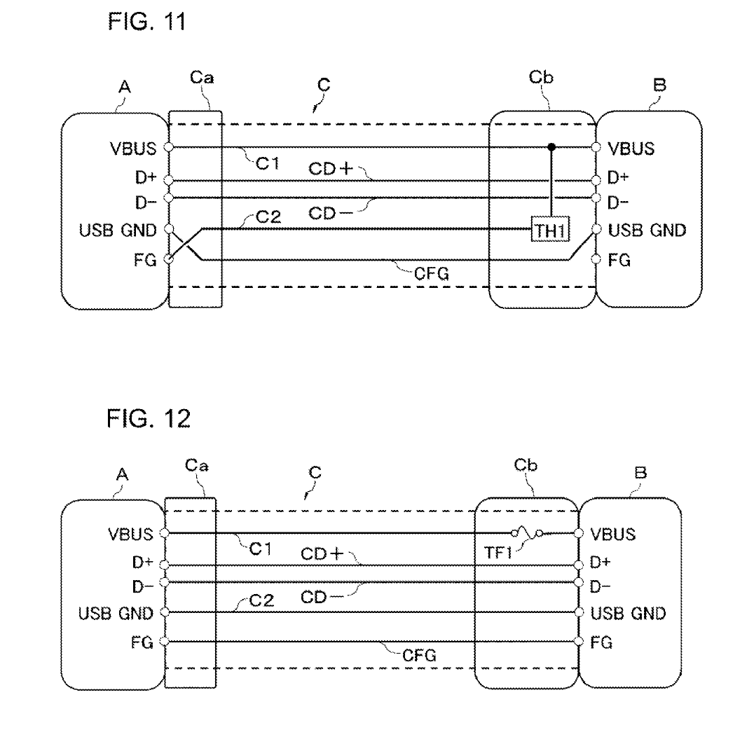

The circuit configuration of the embodiment 8 of the present invention is shown in FIG. 11, In the differences of the embodiment 8 and the embodiment 4, connections of the minus side power supply line C2 and the frame ground line CFG are changed. Other elements are the same as the embodiment 4. In the same elements as the embodiment 4, the same marks are put, and their explanations are omitted.

As shown in FIG. 11, in the plug Cb, the thermal sensitive element TH1 is connected to the plus side power supply line C1 which is connected to the terminal VBUS of the plug Ca, and is connected to the terminal FG of the plug Ca through the minus side power supply line C2. The terminals USB_GND of the plug Ca, Cb are connected by the frame ground line CFG. The minus side power supply line C2 is used as a temperature measuring line of the thermal sensitive element TH1.

In the embodiment 8 in the same way as the embodiment 4, at the abnormal time when the temperature becomes the high temperature range or the temperature increase per unit time becomes equal to or more than a predetermined value, direct current power supply from the direct current power supply device A can be stopped. Measurement error of the resistance value becomes small, and then the temperature can be exactly measured. In the embodiment 8, power loss of charging current can be reduced.

### Embodiment 9

The circuit configuration of the embodiment 9 of the present invention is shown in FIG. 12, In the same elements as the embodiment 1, the same marks are put, and their explanations are omitted.

In FIG. 12, a thermal fuse TF1 connected to the plus side power supply line C1 connecting the terminals VBUS, is provided in the plug Cb. By this electric circuit, when the plug Cb becomes high temperature, the thermal fuse TF1 blows. Thus, direct current power supply from the direct current power supply device A can be stopped.

### Embodiment 10

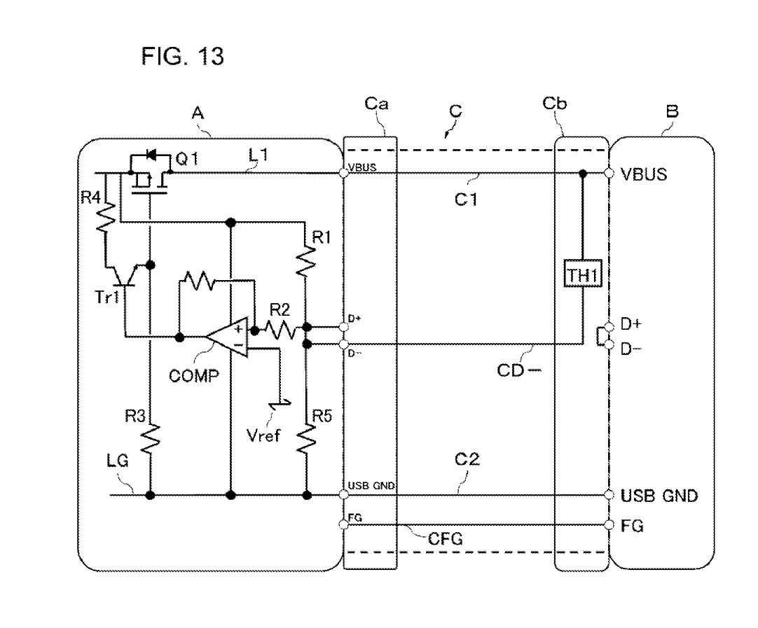

The circuit configuration of the embodiment 10 of the present invention is shown in FIG. 13. In the differences of the embodiment 10 and the embodiment 4, connections of the thermal sensitive element TH1 or TH2 are changed, Other elements are the same as the embodiment 4. In the same elements as the embodiment 4, the same marks are put, and their explanations are omitted.

The circuit configuration of the embodiment 10 of the present invention is shown in FIG. 13. The electrical connecting lines in the electric cable C comprises the plus side power supply line C1 connecting terminals VBUS, the minus side power supply line C2 connecting terminals USB_GND, and the electric connecting line CD− connecting the terminal D−. Then, the thermal sensitive element TH1 having a negative temperature characteristic is disposed in the plug Cb, The electric connecting line CD− is used as a temperature measuring line of the thermal sensitive element TH1.

In the direct current power supply device A, a connecting line connected to the power supply line L1 at the source side of the switching element Q1, is grounded to the grounding line LG of the terminal USB_GND through a series circuit of a resistor R1 and a resistor R5. The terminal D+ and the terminal D− are connected to the middle point of the resistor R1 and the resistor R2, and the connection between the terminal D+ and the terminal D− is in the short circuit state. As the terminal D+ and the terminal D− do not output a specific voltage (for example, 5 V) by the resistor R1 and the resistor R5, even though the normal electric cable for the USB is connected, the electric device B does not unintentionally operate. The thermal sensitive element TH1 is connected between the electric connecting line CD− and the plus side power supply C1.

Assuming that the thermal sensitive element TH1 and a voltage dividing resistor are disposed in the plug Cb and conductive foreign objects exist between the terminals of the plug Cb, it might happen that output of the plus side power supply line C1 is decreased and a predetermined voltage (for example, 5 V) cannot be supplied to the series circuit of the voltage dividing resistor and the thermal sensitive element TH1. However, since the voltage dividing resistor (R5 or the like) of the thermal sensitive element TH1 is disposed in the direct current power supply device A, such a problem is prevented.

In the direct current power supply device A, the terminal D+ is connected to an input terminal of a comparator COMP through the resistor R2, and an output from the comparator COMP is connected to the base of a transistor Tr1.

Output of direct current power of the direct current power supply device A is supplied from the power supply line L1 to the electric equipment B, and then is returned to the grounded line LG. The p-type FET as the switching element Q1 is inserted in series in the power supply line L1 with the drain connected to the output side. Then, the gate of the switching element Q1 is connected to the grounded line LG through the resistor R3. The emitter of the transistor Tr1 is connected to the middle point of the gate of the switching element Q1 and the resistor R3. The collector of the transistor Tr1 is connected to the power supply line L1 through a resistor R4. A power source of the comparator COMP is obtained from the power supply line L1 at the source side of the switching element Q1.

Next, flow of the embodiment 10 is explained. When temperature of the thermal sensitive element TH1 is in the normal temperature range, the resistance value of the thermal sensitive element TH1 in the plug Cb is large, and low voltage is inputted to the input terminal of the comparator COMP, and the low voltage as the OFF signal is outputted from comparator COMP since the inputted low voltage is lower than the reference voltage Vref incorporated in the direct current power supply device A. Thus, the low voltage is applied to the base of the transistor Tr1, and then the transistor Tr1 is in the OFF state. Then, as a current flows through the resistor R3, the gate electrical potential is lower than the source electric potential in the switching element Q1, and then the switching element Q1 is in the ON state, and power is supplied.

When temperature of the thermal sensitive element TH1 is in the high temperature range, the resistance value of the thermal sensitive element TH1 in the plug Cb becomes small, and high voltage is inputted to the input terminal of the comparator COMP, and the high voltage as the OFF signal is outputted from comparator COMP since the inputted high voltage is higher than the reference voltage Vref incorporated in the direct current power supply device A. Thus, the high voltage is applied to the base of the transistor Tr1, and then the transistor Tr1 is in the ON state. Then, as the gate electrical potential in the switching element Q1 connected to the middle point of the resistor R3 and the resistor R4 becomes high, and the switching element Q1 becomes the OFF state, and then the switching element Q1 becomes the OFF state. Namely, when the thermal sensitive element TH becomes the high temperature range, as the direct current power supply device A does not supply power to the electric cable C, abnormal heat generation at the plug Cb can be prevented.

### Embodiment 11

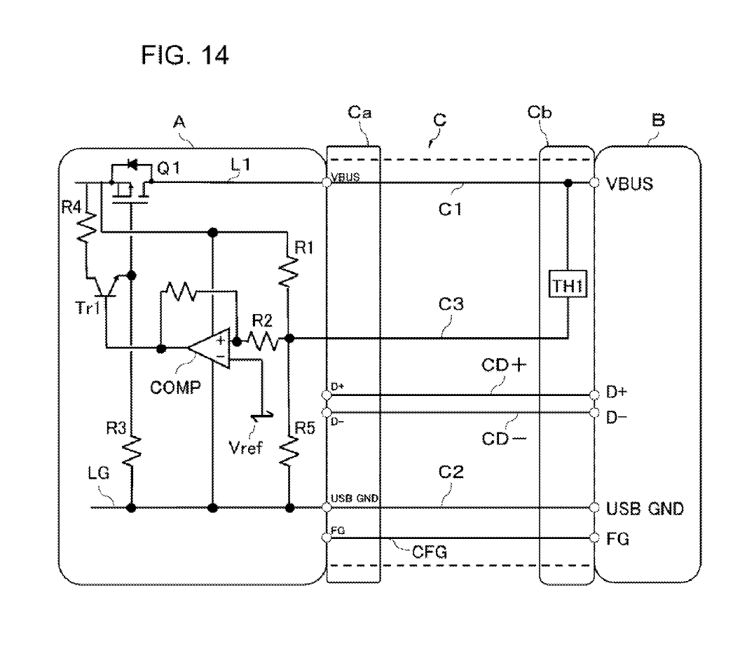

The circuit configuration of the embodiment 11 of the present invention is shown in FIG. 14. In the differences of the embodiment 11 and the embodiment 10, the electric connecting line C3 for detecting the thermal sensitive element TH1 is connected at the middle point of the resistor R1 and the resistor R5. The terminal D− and the terminal D+ of the direct current power supply device A are connected to the terminal D− and the terminal D+ of the electric device B, and it is possible to communicate by terminals D. Other elements are the same as the embodiment 10. In the same elements as the embodiment 10, the same marks are put, and their explanations are omitted.

In the electric cable C, the electric connecting line CD+ and the electric connecting line CD− are connected to the terminal D+ and the terminal D−, and to the electric device B. The thermal sensitive element TH1 having a negative temperature characteristic is disposed in the plug Cb, and connected to the positive side power supply line C1.

The electric connecting line C3 as a temperature measuring line of the thermal sensitive element TH1 is at the middle point of the resistor R1 and the resistor R5. Here, the electric connecting line CD+ and the electric connecting line CD− are independent from the electric connecting line C3, and it is possible to communicate by terminals D.

By such configuration, in the embodiment 11 in the same way as the embodiment 10, abnormal heat generation at the plug Cb can be prevented and it is possible to also communicate by terminals D.

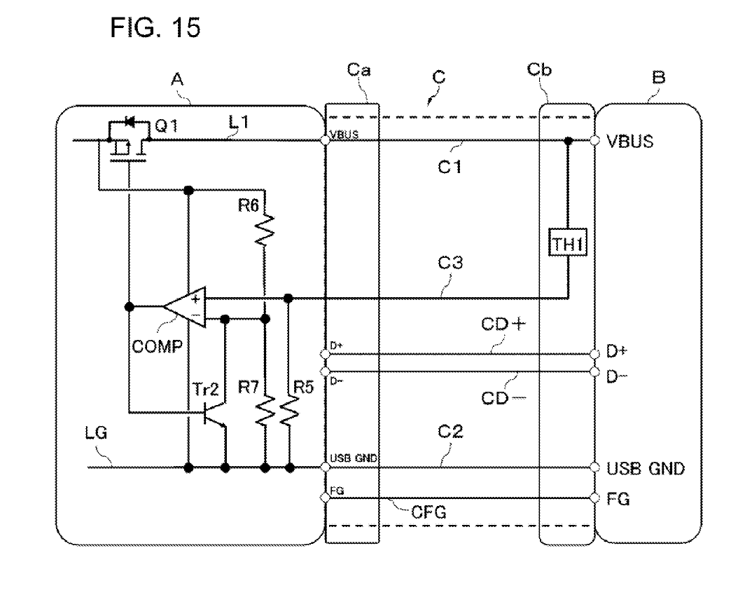

In addition, an application of the embodiment 11 of the present invention is shown in FIG. 15. As the differences from FIG. 14, in the direct current power supply device A, a resistor R6 and a resistor R7 as voltage dividing resistors are connected between the power supply line L1 and the grounded line LG, its middle point as the reference voltage is inputted to the comparator COMP. The middle point of the thermal sensitive element TH1 and the resistor 5 as the measured voltage is inputted to the comparator COMP. The resistance values of the resistors R5, R6, R7 are set such that the measured voltage is equal to or less than the reference voltage at the normal temperature range in the temperature of the thermal sensitive element TH1 and the measured voltage is more than the reference voltage at the high temperature range in the temperature of the thermal sensitive element TH1. Further, an output signal of the comparator COMP is connected to the gate of the switching element Q1 and the base of a transistor Tr2, and the collector and the emitter of the transistor Tr2 are connected in parallel with the resistor R7.

In such circuit configuration, in the high temperature range of the temperature of the thermal sensitive element TH1, the resistance value of the thermal sensitive element TH1 in the plug Cb becomes small, and a high voltage is inputted to the input terminal of the comparator COMP, and the high voltage is higher than the reference voltage of the resistor R6, R7, and a high voltage is outputted from the comparator COMP. Thus, as the high voltage is applied to the gate of the switching element Q1, the switching element Q1 is in the OFF state. The high voltage is also applied to the base of the transistor Tr2, and the transistor Tr2 becomes the ON state. As long as the output of the direct current power supply device A does not decrease, the OFF state of the switching element Q1 is kept, and then the so-called latch operation is possible. Namely, in the high temperature range of the temperature of the thermal sensitive element TH1, the direct current power supply device A does not supply power to the electric cable C, and then abnormal heat generation at the plug Cb can be prevented.

### Embodiment 12

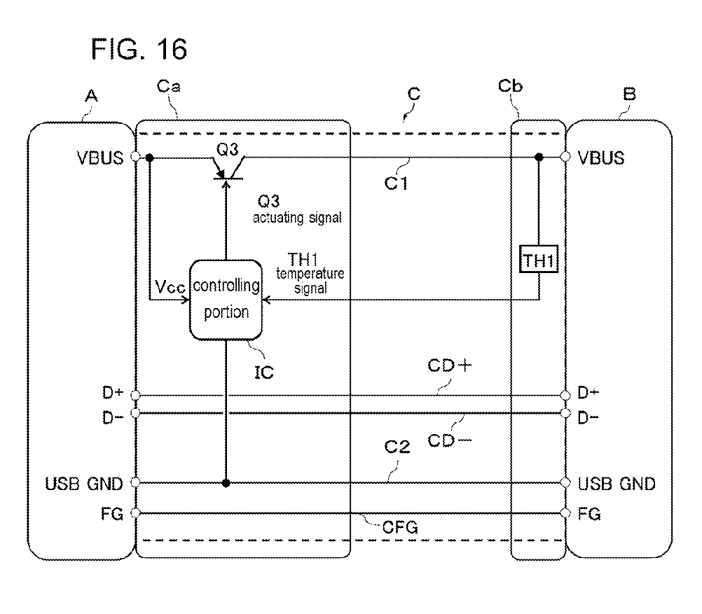

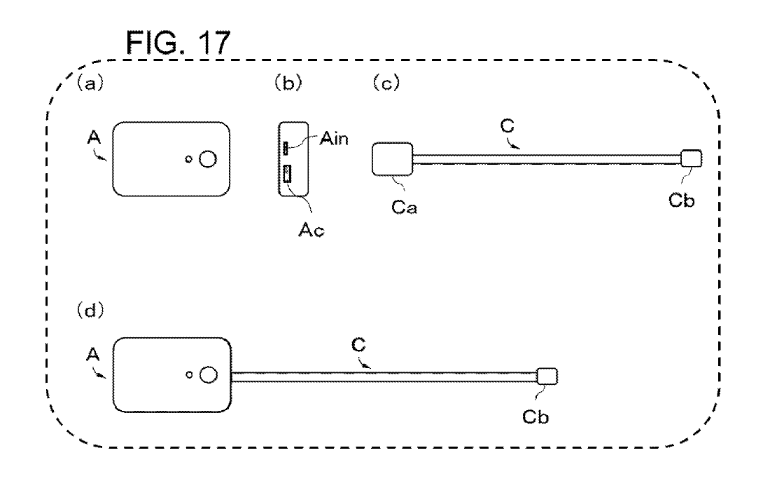

The circuit configuration of the embodiment 12 of the present invention is shown in FIG. 16. In the differences of the embodiment 12 and the embodiment 1, the switching element Q1, Q2, and the resistor R1 to R3 in the plug Cb are removed, and connections of the thermal sensitive element TH1 are changed. In addition, a switching element Q3 and a controlling portion IC are added in the plug Ca. Other elements are the same as the embodiment 1. In the same elements as the embodiment 1, the same marks are put, and their explanations are omitted. In place of the thermal sensitive element TH1, a thermal sensitive element TH2 in which the resistance value decreases in non-linear with temperature increase, can be used.

As shown in FIG. 16, in the plug Cb, the thermal sensitive element TH1 is connected to the plus side power supply line C1 which is connected to the terminal VBUS of the plug Cb, and is connected to the controlling portion IC of the plug Ca through the electric connecting line C3 as the temperature measuring line of the thermal sensitive element TH1.

In the plug Ca, the switching element Q3 is disposed in series in the plus side power supply line C1. The controlling portion IC is connected to the plus side power supply line C1 and the minus side power supply line C2, and a driving power is inputted. The controlling portion IC inputs a temperature signal of the thermal sensitive element TH1 from the electric connecting line C3, and transmits an actuating signal to the switching element Q3.

In the embodiment 12, at the abnormal time when the temperature becomes the high temperature range or the temperature increase per unit time becomes equal to or more than a predetermined value, the controlling portion IC inputs the temperature signal of the thermal sensitive element TH1, and transmits the actuating signal so as to carry out the OFF state of the switching element Q3. From controlling by the controlling portion IC, direct current power supply from the direct current power supply device A to the electric device B can be stopped.

Here, the thermal sensitive element TH1 is connected to the plus side power supply line C1 in the plug Cb. Instead, the thermal sensitive element TH1 may be connected to the minus side power supply line C2. The switching element Q3 is disposed in series in the plus side power supply line C1 in the plug Ca. Instead, the switching element Q3 may be disposed in series in the minus side power supply line C2 in the plug Ca.

### Other Embodiment

Here, in the embodiment 1 to 12, as shown in FIG. 17(a) to (c), the electric cable C has the plug Ca at the direct current power supply device A side, but as shown in FIG. 17(d), the plug Ca is omitted, and the electric cable C may be directly connected to the direct current power supply device A. Further, a cable portion of the electric cable C is omitted, and the plug Cb may be directly connected to the direct current power supply device A.

FIG. 17 is explained in detail. FIG. 17 is an outer appearance view showing the other embodiment of the present invention, and FIG. 17(a) is a front view of the direct current power supply device, and FIG. 17(b) is its right side view, and FIG. 17(c) is a front view of the electric cable, and FIG. 17(d) is a front view of the AC adapter.

As shown in FIG. 17(a), (b), the direct current power supply device A has an approximate box shape in the outer appearance, and incorporates the secondary battery (not shown) inside. The direct current power supply device A inputs power from a connector Ain (for example, the USB (micro Type B)) for a charging input which is located at the side surface thereof, and then the secondary battery is charged. Then, the direct current power supply device A outputs power stored in the secondary battery from a connector Ac (for example the USB (Type A)).

FIG. 17(c) shows the electric cable C. The electric cable C has the plug Ca of the USB (Type A) at the direct current power supply device A side, and has the plug Cb of the USB (micro Type B) at the electric device B side.

The above-mentioned abnormal heat generation at the plug often occurs in the plug Cb of the small size USB (micro Type B). Therefore, in the present embodiment, the thermal sensitive element TH1 is provided in the plug Cb.

FIG. 17(d) shows the direct current power supply device A which does not have the plug Ca and is directly connected to the electric cable C. Plugs (not shown) which are inserted into the commercial power supply outlet, are provided at the rear surface of the direct current power supply device A. Direct current power converted from the commercial power supply, is outputted from the output plug (for example, the USB (micro Type B)) for supplying power through the electric cable C which is attached and fixed to the AC adapter.

Here, in the embodiments 1 to 12, temperature increase is measured by using changes in the resistance value of the thermal sensitive element TH1, TH2, but a thermal sensitive element TH3 which outputs voltage can be used. For example, the thermal sensitive element TH3 has a temperature change characteristic in which forward voltage changes at ΔV/ΔT (=C) in linear with temperature increase, and its forward voltage is shown as a numerical formula 2.

V=V0+E×(T−T0) (numerical formula 2)
V: forward voltage (V) of the thermal sensitive element TH3
V0: forward voltage (V) of the thermal sensitive element at normal temperature (25° C.)
E: a constant of −0.002
T: temperature (° C.) of the thermal sensitive element
T0: normal temperature 25° C.

For example, the thermal sensitive element TH3 has the temperature change characteristic of E=−0.002 (V/° C.), and the forward voltage V0=0.6 V at the normal temperature (25° C.). When temperature of this thermal sensitive element TH3 increases till 60° C., the forward voltage V of the thermal sensitive element TH3 becomes 0.53 V as described in a numerical formula 3. Namely, when the forward voltage V of the thermal sensitive element TH3 becomes 0.53 V or more, the direct current power supply device A carries out the protection action. Thus, the protection system at absolute temperature of 60° C. can be provided.

V=0.6+(−0.002×(60−25))=0.53 (numerical formula 3)

Here, in the embodiments 1 to 12, the thermal sensitive element TH1, TH2 is provided in the plug Cb, but the thermal sensitive element TH1, TH2 can be provided in the plug Ca at the direct current power supply device A side. In that case, heat generation at the plug Ca of the direct current power supply device A side can be detected early.

Here, in the embodiments 1 to 12, the thermal sensitive element TH1, TH2 is provided in the plug Cb, but the thermal sensitive element TH1, TH2 can be provided in the plug Ca. In addition, the thermal sensitive element TH1, TH2 can be provided at both the plug Cb and the plug Ca. In that case, heat generation at the plug Ca and the plug Cb can be detected early.

In a case where the small size plug such as the mini-USB plug, or the micro-USB plug as the plug is used, heat radiation at the abnormal heat generation is small because of its small size. However, by using these embodiments, the abnormal heat generation can be precisely detected, and the abnormal heat generation can be prevented early.

Here, in the embodiments 1 to 12, the direct current power supply devices are used, but a power supply device which outputs current such as an AC current superposed on a DC current, pulse waveform current, or sawtooth waveform current, can be used.

### INDUSTRIAL APPLICABILITY

The electric cable and the power supply device related to the present invention, can prevent the plug from becoming abnormally high temperature, even in a small size electric cable or an electric cable using a standardized plug. Therefore, the electric cable connecting the power supply device and the mobile electric device, and the power supply device using its cable can be useful in a case where charging current is supplied from the power supply device to the electric device.

### REFERENCE MARKS IN THE DRAWINGS

A: direct current power supply device
A1: charging and discharging circuit portion
A2: secondary battery
A3: controlling portion
A4: ON/OFF switch
Ac, Ain: connector
B: electric device
Bc: connector
C: electric cable
Ca, Cb: plug
Cb1: insert portion
Cb2: outer mold portion
Cb3: metal chassis
Cb4: cutout portion
Cb5: core portion
Cb6: circuit board
Cb7: electrical connecting line group
C1: plus side power supply line
C2: minus side power supply line
C3, CD+, CD−: electric connecting line
CFG: frame ground line
TH1, TH2, TH3: thermal sensitive element
Q1, Q2, Q3: switching element
IC: controlling portion
TF1: thermal fuse
COMP: comparator

1. An electric cable comprising:
an electrical connecting line group having power supply lines for supplying power by a plus-side power supply line and a minus-side power supply line; and
a plug disposed to at least one end of the electrical connecting line group,
wherein the plug comprises a thermal sensitive element, an insert portion which is inserted into an external electric device, and a metal chassis which is electrically connected to a frame ground of the insert portion and surrounds the thermal sensitive element,
a connection structure of the insert portion and the metal chassis partially has a cutout portion, and
a resin portion having a heat conduction coefficient of 0.2 (W/mK) or less, or an air layer disposed between the metal chassis and the thermal sensitive element.

2. The electric cable according to claim 1,
wherein the electrical connecting line group has a temperature measuring line wired in parallel with the power supply lines, and
the thermal sensitive element is connected to the power supply line and the temperature measuring line.

3. The electric cable according to claim 2,
wherein the thermal sensitive element is connected to the plus-side power supply line.

4. The electric cable according to claim 2,
wherein the temperature measuring line is a braided wire.

5. The electric cable according to claim 2,
wherein the minus-side power supply line is a braided wire.

6. The electric cable according to claim 1,
wherein the plug is any one of a USB, a mini-USB, and a micro-USB.

7. The electric cable according to claim 2, further comprising:
a second plug disposed to another end of the electrical connecting line group;
a switching element disposed inside the second plug, and connected in series to one of the power supply lines; and
a controlling portion disposed inside the second plug for carrying out ON/OFF control of the switching element based on input from the temperature measuring line.

8. The electric cable according to claim 1,
wherein the thermal sensitive element is connected to one of the power supply lines; and
a switching element connected in series to one of the power supply lines, the switching element configured to open responsive to a change in output from the thermal sensitive element.

9. The electric cable according to claim 1,
wherein the electrical connecting line group has two temperature measuring lines wired in parallel with the power supply lines, and
the thermal sensitive element is connected to the two temperature measuring lines.

10. (canceled)

11. A power supply device connected to the electric cable according claim 1,
wherein the power supply device controls power supply based on a change in output from the thermal sensitive element through the temperature measuring line.

12. The power supply device according to claim 11, further comprising:
a resistor connected in series to the thermal sensitive element;
a comparator for comparing a divided voltage by the thermal sensitive element and the resistor with a reference voltage; and
a switching element for carrying out ON/OFF control of the power supply based on output from the comparator.
